(19) United States
(12) Patent Application Publication
(10) Pub. No.: US 2002/0091842 A1
(43) Pub. Date: Jul. 11, 2002

(54) Credit inquiry method and system

(76) Inventor: Raymond C. Hoffeld, Fleetwood, PA (US)

Correspondence Address: Joseph W. Berenato, III, Liniak. Berenato, Longacre & White, LLC, 6650 Rock Spring Drive, Ste. 240, Bethesda, MD, 20817, US

(21) Appl. No.: 10/035,246

(22) Filed: Jan. 4, 2002

Related U.S. Application Data
(60) Provisional application No. 60/259,867, filed on Jan. 8, 2001.

(51) Int. Cl. G06F 15/16

(52) U.S. Cl. 709/229; 713/200

(57) ABSTRACT

An automated system for disseminating information from a company to a third party about customers of the company is disclosed. The information disseminated relates to a relationship between the company and one of its customers. The company provides a website having a secure portion that may be accessed only via a previously assigned ID and password. The company provides the Customer Account Number, but the Commercial Identification Number may be assigned or changed by the customer. The customer thus controls access to the information to be provided to a third party, because it must supply both numbers to those who are to be able to access the stored information. The system eliminates the necessity of manually completing requests. By automating the system, information retrieval is consistent, quicker, and allows for central administration control and monitoring of all inquiries. Response to third parties wishing to obtain information is almost instantaneous.

### CROSS REFERENCE TO RELATED APPLICATION

This application claims the benefit of U.S. Provisional Application No. 60/259,867, filed Jan. 8, 2001, the disclosure of which is incorporated herein by reference.

### REFERENCE TO COMPUTER PROGRAM LISTING APPENDIX

The computer program listing appendix container in the file “Sourcecode.txt” on compact disc 1 of 1, which has been filed with the United States Patent and Trademark Office in duplicate, is hereby incorporated by reference. The file was created on Dec. 17, 2001, and is 263,153 bytes in size.

### BACKGROUND OF THE INVENTION

1. Field of the Invention

This invention relates to the secure dissemination of information between entities. More specifically, this invention is directed to implementation of a website by one corporation in order to permit secure access to credit information of its customers by third parties authorized by the customers to have access to that credit information.

2. Description of Related Art

Often times a first company will contact a second company to inquire about a customer's business relationship with that second company. The inquiry seeks information about the credit history between the customer and the second company. The first company may request a report about the about the credit history between the second company and the customer. The second company will provide the first company with some or all the requested information or like information. The second company usually is not obligated to provide the credit information, but does so as a service to its own customers. This service is beneficial to the second company's customers, who seek credit with entities requiring credit references before extending any form of credit or business.

Contact is usually made by telephone, facsimile, letter, or e-mail. In order to respond to an inquiry, the second company must allocate resources in the form of manpower, time, and money to answer the individual requests. Generally, the larger the company, the greater the volume of requests it receives. Supplying the information, while a benefit for customers, creates a burden on the second company's staff, consuming up to twenty percent of an employee's available work time. Employees must retrieve the information from a computer or other source and communicate the information to the first company via phone, letter, e-mail or facsimile. Additionally, if the second company has more than one plant or office, all relevant information may not be centrally located, and additional time and resources will be required in order to provide the requested information. Information that is held at various locations may not be included in the response due to its unavailability or lack of knowledge on the part of the individual compiling the information. Moreover, where the second company has multiple locations, each location might respond differently to a request, possibly creating confusion and inconsistency. Also, the individual charged with providing the information might not be available, possibly delaying the response and causing the customer to be denied credit or business.

In addition to increasing overhead for the second company, sometimes the request does not come from a legitimate source. A company may request credit information for purposes other than those communicated. For example, a company may wish to determine why a customer has failed to meet the normal volume for a given period. The current methods of providing credit information do not prevent a competitor from seeking a credit report from another company about its business with a particular customer. Companies in competition often seek the type of information provided. A customer's relationship with other companies may be affected by this freely obtained information. In order to prevent responding to such improper inquiries, a company would have to spend an inordinate amount of time and resources checking on whether each inquiry was legitimate.

### SUMMARY OF THE INVENTION

It is therefore an object of the present invention to provide a method wherein predetermined information about a customer is stored on a storage device under the control of a host. Access to the predetermined information is limited by creating a general identification and a specific identification specific to the customer. The general identification links the predetermined information to the customer. The specific identification is used by the customer to control the access to the predetermined information. A customer informs a third party of the general and specific identification, thereby allowing the third party to gain access to the predetermined information.

The present invention also provides a computer system allowing access to predetermined information. The computer system stores the predetermined information on a storage device of a host's computer. Within the computer system is a general and a specific identification particular to a company, e.g., a customer. The general identification links the predetermined information to the customer. The specific identification allows for access to the predetermined information. A third party accesses the computer system to view the predetermined information, after being provided the general and specific identification by the customer.

The present invention also pertains to secure and selective computer access to credit information between a first company and a second company with which the first company does business. The credit information is stored on a storage device, and access to the credit or other information is limited. A general identification is created for the first company when it begins doing business with the second company, and credit history and other information about the first company is associated with this general identification. The first company also creates a specific identification used to control access to the information associated with its general identification. The general and specific identifications also limit access to the credit information. A third party may access the credit information on the storage device only after providing the general and specific information.

An advantage of the present invention is nearly complete automation of the inquiry process, thus significantly reducing the need to manually complete requests. In applicant's experience, the number of credit inquiries that had to be handled manually was reduced by over 75% once the system was implemented. By automating the process, information retrieval is consistent, quicker, and allows for central administration control and monitoring of all inquiries. In addition, a log can be kept so that the various incoming inquiries can be reviewed as needed. Response to third parties wishing to obtain information is almost instantaneous. Costs associated with maintaining this service are substantially less than the costs associated with the prior manual response system.

These advantages and other novel features of the present invention will become apparent in the following detailed description of the invention when considered in conjunction with the accompanying drawings.

### BRIEF DESCRIPTIONS OF THE DRAWINGS

A better understanding of the present invention will be had when reference is made to the accompanying drawings, wherein identical parts are identified by identical reference numbers and wherein:

FIG. 1 is schematic diagram depicting the relationship between several entities;

FIG. 2 is a flow chart setting forth the process steps of the invention; and

FIG. 3 is a flow chart setting forth the process for accessing a host's website.

### DETAILED DESCRIPTION OF THE INVENTION

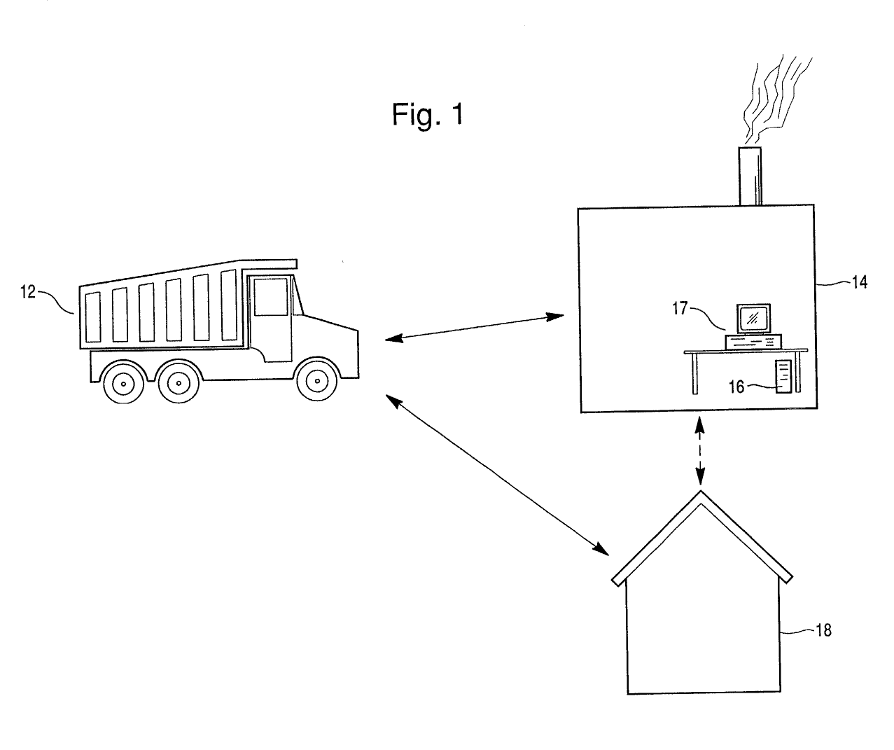

The features of the invention as explained above provide an innovative technique for providing information about a business relationship between two entities to a third party. As best shown in FIG. 1, a customer 12 conducts business with a host 14. The customer 12 may wish to use the established relationship with the host 14 as a reference. The customer 12 may wish a third party 18 to be provided with information relating to the relationship, e.g., credit history, between the customer 12 and the host 14.

The host 14 maintains information concerning the transactions occurring during the business relationship with customer 12. Preferably the information is stored within a storage device 16 on the host's computer 17. The storage device may include computer RAM, a hard drive, a disk, an independent server, etc. Computer storage of the information permits access by numerous individuals or entities, and permits the host 14 to control access to the information, the format of the information, and the precise information to be made available.

The stored information may relate to the credit history between the customer 12 and the host 14. The credit history includes information such as largest credit amount extended to the customer, length of time required for the customer 12 to pay debts, the duration during which the customer 12 and host 14 have been conducting transactions, general terms of sale, and the date of the last transaction between the customer 12 and the host 14. Other information, of course, could also be stored. All or selected portions of this information may be made available to third parties. For example, while the information may include data on all transactions between the customer and the host, only data from the past five years, or data concerning certain types of transactions, for example, may be made available to third parties.

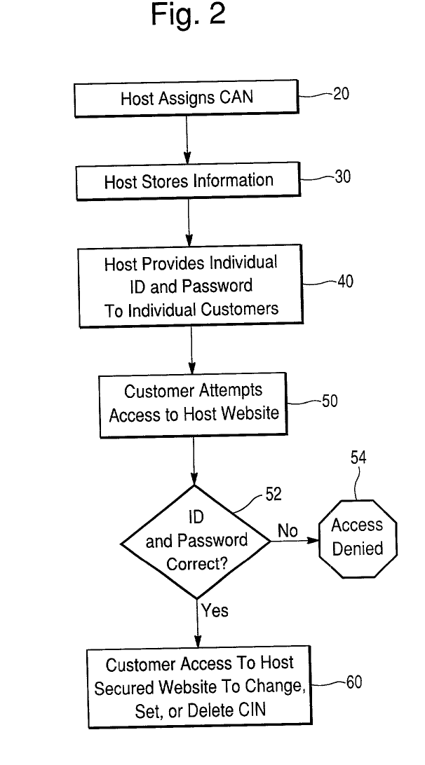

As best shown in FIG. 2, the host 14 assigns a general identification number to customer 12 at 20 when the customer opens an account or begins doing business with the host. Information about the customer's relationship with the host, credit information, for example, is thereafter stored in a file associated with this general identification number at step 30. This general identification number is known as the Customer Account Number (“CAN”), and only the host 14 may alter or change the customer's assigned CAN. The CAN may be a sequence of any length comprised of any combination of numbers and/or letters. The CAN preferably comprises no more than ten alphanumeric characters. Information about customer 12 stored on computer 16 is linked to that customer 12 by the CAN.

Preferably host 14 maintains a website that may be accessed via the Internet or other communications system. Customers may access a secure area within the main website. Alternatively, the host 14 may establish a dial-up connection for customers via standard phone connections. Each customer 12 has selective access to the secure area established by the host 14, via a customer ID and password assigned at step 40.

In addition to the CAN created at 20, a specific identification is created by or for customers desiring to use host 14 as a credit reference. The specific identification is known as the Commercial Identification Number (“CIN”). The CIN may be comprised of numbers and/or letters. The CIN is limited preferably to no more than ten alphanumeric characters. Only the customer 12 and the host 14 initially know the CIN. There are several ways in which a customer 12 may obtain a CIN. The host 14 may assign a CIN to a customer 12, the customer 12 may assign its own CIN within the secure area of host 14, or the customer 12 may request that the host 14 assign a particular CIN. The host 14 then confirms to customer 12 the CIN that has been assigned. The customer 12 sets its own CIN or may receive the CIN from the host 14 via mail, e-mail, facsimile, telephone, in person, etc. Once the CAN and CIN have been established, then the website of the host 14 may be accessed by the customer and/or third parties to whom the customer provides the CAN and CIN. The information that may be accessed is limited by the host 14, and access to the secure area of the website does not permit unrestricted access to the entirety of the website or to the computer network of the host 14. The CIN may be changed by the customer 12, thus permitting the customer to control access by third parties to its information.

The customer 12 accesses the secure portion of the website of host 14 commencing at step 50. The customer is prompted to enter a previously applied-for and assigned ID and password at 52 and access is denied at step 54 if the ID or password is incorrect. Within the secure area at 60 there are instructions and ability for the customer 12 to initially choose and set a CIN, change the CIN, or delete the CIN permanently. This allows the customer 12 to control the access to the stored information on the website by third parties 18.

Rather than having the third party 18 submit requests to the host 14 regarding the information retained by host 14 about customer 12, the third party 18 can access the website of the host 14 in order to obtain the information about the customer 12. The customer 12 must inform the third party 18 of the correct CAN and CIN in order to allow the third party 18 to gain access to the information stored on the host's computer through the website. In this way, the host 14 does need to dedicate personnel to responding to inquiries and can control the types of information that it provides. Additionally, the customer 12 controls who can access the information, thus substantially eliminating the ability of a competitor of host 14 to inquire about customer 12. Also, because access is achieved by Internet communications, information can be obtained at a time convenient to the third party.

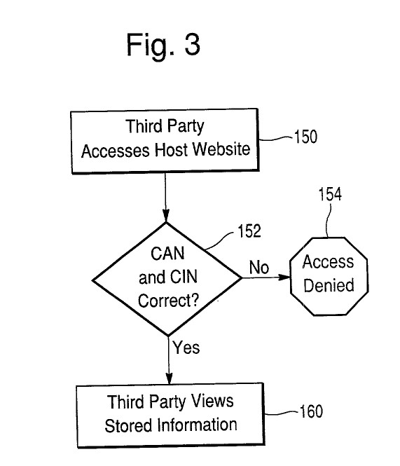

As best shown in FIG. 3, the third party 18 attempts to accesses the host's website at 150. The third party 18 is prompted to enter the CAN and CIN that correspond to the customer 12 at step 152. If either CAN or CIN, or both, are incorrect then access is denied at step 154. If both CAN and CIN are correct, the third party 18 can access the information pertaining to the customer 12 stored by the host 14. The computer 17 of the host 12 automatically retrieves the stored or predetermined information from the daily updated records, and provides this information to third party 18 at step 160.

When a third party 18 attempts to obtain access to the stored information via the website, the host 14 may request that certain information be provided prior to access being granted. This would be requested at or prior to step 152. Such information may include the third party's name and address, Federal identification number, Data Universal Numbering System (DUNS) number, the name and title of the individual making the request, and any other information host 14 wants to obtain. This information, as well as the date of the inquiries and number of inquiries made is store in a log that can be accessed as needed.

The customer 12 may limit or terminate access by a third party 18 to its information by changing its CIN. Customer 12 may, for example, change its CIN on a periodic basis. Alternatively, it may change it within a defined period after having supplied it to a third party 18. Access of third parties 18 though changing the CIN allows customer 12 to control who can access its information.

FIG. 1 illustrates the flow of information between the host 14, customer 12 and the third party 18. Information flow requiring human interaction or involvement is indicated by a line, with arrows indicating the direction of information flow. The host 14 and the customer 12 communicate information for every business transaction. The customer 12 and third party 18 similarly interact during business relationships. By automation of the above-mentioned process, the host 14 communicates with the third party 18 only through electronic means, as indicated by the dashed lines, saving valuable resources.

While the foregoing invention has been shown and described with reference to several preferred embodiments, it will be understood that various changes in form and detail may be made without departing from the spirit and scope of the present invention.

What is claimed is:

1. A method of permitting selective computer access to information about a first entity by a second entity, comprising the steps of:
storing predetermined information about a first entity on a storage device of a host computer, wherein access to the storage device is decisively limited;
creating via a host entity a general identification specific to the first entity, and through the host computer linking the predetermined information to the general information of the first entity;
creating via the first entity a specific identification permitting access to the predetermined information stored on the storage device; and
informing via the first identity a second entity of the general and specific identification, and therefore permitting the second entity to access the storage device and review the predetermined information.

2. The method of claim 1, including the step of storing credit information as the predetermined information.

3. The method of claim 2, including the step of storing credit information of a predetermined duration.

4. The method of claim 3, including the step of storing credit information created within the previous five years.

5. The method of claim 2, including the step of storing information extracted from said credit information.

6. The method of claim 1, including the step of permitting access to the storage device via a website of the host entity.

7. The method of claim 1, including the step of creating the general identification specific to the first entity from the group consisting of alphanumeric sequences, numeric sequences, and combinations thereof.

8. The method of claim 1, including the step of creating the specific identification via the first entity from the group consisting of alphanumeric sequences, numeric sequences, and combinations thereof.

9. The method of claim 1, including the step of limiting the general and specific identification to no more than ten digits.

10. The method of claim 1, including the step of storing the specific identification on the storage device of the host entity.

11. The method of claim 8, including the step of permitting the first entity to assign or change the specific identification.

12. A computer system for storing information concerning transactions between a first entity and a second entity and selectively permitting a third entity to access selected portions of said information comprising:
a data storage device controllable by said second entity and connected to a network accessible by said third entity;
information stored on said data storage device concerning transactions between said first entity and said second entity;
a general first party identifier stored on said data storage device and associated with said information;
a specific first party identifier stored on said data storage device and associated with said information; and
a data processor for providing access to a selected portion of said information over said network to a third party after said third party sends said general first party identifier and said specific first party identifier over said network to said data processor.

13. The system of claim 12, wherein said data storage device comprises a memory device capable of receiving and storing information from at least the first entity and the second entity.

14. The system of claim 12, wherein said general identifier and said specific identifier each comprise an alphanumerical sequence, a numerical sequence, or combination thereof.

15. The system of claim 14, wherein said general identifier sequence comprises fewer than ten characters.

16. The system of claim 12, wherein said specific first party identifier is changeable by said first party.

17. The system of claim 12, wherein said information comprises credit information.

18. The system of claim 17, wherein said credit information comprises credit information from a limited period of time.

19. The system of claim 12, wherein said selected portion of said information comprises less than all said information.

20. A method of permitting selective computer access to credit information about a first entity by a second entity, comprising the steps of:
storing credit information about a first entity on a storage device of a host computer, wherein access to the storage device is decisively limited;
creating via a host entity a general identification specific to the first entity, and through the host computer linking the credit information to the general identification of the first entity;
creating via the first entity a specific identification permitting access to the credit information stored on the storage device; and
informing via the first identity a second entity of the general and specific identification; and
permitting the second entity to access the storage device and review the credit information through use of the storage device.
